(19) United States
(12) Patent Application Publication
(10) Pub. No.: US 2025/0167389 A1
(43) Pub. Date: May 22, 2025

(54) BATTERY CELL AND BATTERY MODULE INCLUDING THE SAME

(71) Applicant: Samsung SDI Co., Ltd., Yongin-si (KR)

(72) Inventors: Kwang Hyeon LEE, Yongin-si (KR); Jun Woo CHO, Yongin-si (KR)

(21) Appl. No.: 18/649,841

(22) Filed: Apr. 29, 2024

(30) Foreign Application Priority Data
Nov. 19, 2023 (KR) 10-2023-0159931

(51) Int. Cl. H01M 50/30; H01M 50/188; H01M 50/507; H01M 50/516; H01M 50/567

(52) U.S. Cl. CPC H01M 50/394; H01M 50/188; H01M 50/507; H01M 50/516; H01M 50/567

(57) ABSTRACT

A battery cell includes: an electrode assembly; a case accommodating the electrode assembly; a cap plate sealing an opening in the case; and a terminal part connected to the cap plate and having a guide part along which a gas generated when a busbar is welded to the terminal part is discharged to the outside.

### CROSS-REFERENCE TO RELATED APPLICATION

The present application claims priority to and the benefit of Korean Patent Application No. 10-2023-0159931, filed on Nov. 19, 2023, in the Korean Intellectual Property Office, the entire disclosure of which is incorporated herein by reference.

### BACKGROUND

### 1. Field

Aspects of embodiments of the present disclosure relate to a battery cell and a battery module including the same.

### 2. Description of the Related Art

Generally, a battery module (also referred to as a “module”) is a battery assembly including a number of battery cells (also referred to as “cells”) that are grouped together and then accommodated in a frame to be protected from an external impact, heat, vibration, etc. A battery module may include a number of cells connected to each other in series and/or parallel and embedded in a mechanical structure.

The module is commonly referred to collectively as a “battery,” but the module is constituted by a “cell,” a “module,” and a “pack.” Each battery cell plays a role in storing and releasing energy. Because the battery cell itself has a relatively small capacity, a number of battery cells are bundled together to manufacture the module, and then, the modules are combined to manufacture the pack. It may be said that a source of the battery is the cell, a unit that bundles the batteries is the module, a unit that bundles the modules is the pack.

A plurality of battery cells are electrically connected by, for example, a busbar to be are connected in series and/or parallel.

The above-described information disclosed above acts as the background of the present disclosure and is for improving understanding of the background of the present disclosure and, thus, may include information that does not constitute the related (or prior) art.

### SUMMARY

Embodiments of the present disclosure provide a battery cell exhibiting improved welding strength between a cell terminal and a busbar and a battery module including the battery cell.

Other embodiments, and aspects and features thereof, provide a battery cell that can easily discharge a gas generated when a cell terminal and a busbar are welded together and a battery module including the same.

However, aspects and features of the present disclosure are not limited to those described above, and other aspects and features not mentioned will be clearly understood by those skilled in the art from the detailed description and the claims, provided below.

According to an embodiment of the present disclosure, a battery cell includes: an electrode assembly; a case accommodating the electrode assembly; a cap plate sealing an opening in the case; and a terminal part connected to the cap plate and having a guide part along which a gas generated when a busbar is welded to the terminal part is discharged to the outside.

The terminal part may include: a terminal rivet in the cap plate and connected to the terminal part; and a terminal plate electrically connected to the terminal rivet and having with an area that is in contact with the busbar and an area that is spaced apart from the busbar.

The terminal plate may include: a plate body outside the cap plate and electrically connected to the terminal rivet; a connection hole extending in a vertical direction through the plate body to accommodate the terminal rivet therein; a first guide part defining a groove outside the connection hole; and a second guide part defining a groove that connects the first guide part to the outside of the plate body.

The groove of the first guide part may extend in a ring shape along an outer circumference of the connection hole.

A distance between the first guide part and the busbar may be in a range of 0.1 mm to 0.4 mm.

The second guide part may define a plurality of grooves.

The second guide part may extend radially from the connection hole.

The second guide part may have a cross shape with the connection hole as its center.

The terminal plate may have a terminal top surface protruding from the plate body toward the busbar to be in surface contact with and electrically connected to the busbar.

The terminal top surface may be above the first guide part.

According to another embodiment of the present disclosure, a battery module includes: a battery cell including a terminal part electrically connected to an electrode assembly; a busbar electrically connected to the terminal part; and a welding fixing part fixing the busbar to the terminal part. A gas generated when the welding fixing part is formed is discharged to the outside of the terminal part through a space defined between the terminal part and the busbar.

The busbar may include: a first connection plate that is in contact with and electrically connected to the terminal part; a second connection plate spaced apart from the first connection plate and in contact with and electrically connected to a terminal part of an adjacent battery cell; and a curved connection part connecting the first connection plate to the second connection plate and having a curved surface.

The terminal part may include: a terminal rivet in a cap plate of the battery cell and connected to the terminal part; and a terminal plate electrically connected to the terminal rivet and having an area in contact with the busbar and an area spaced apart from the busbar.

The terminal plate may include: a plate body outside the cap plate and electrically connected to the terminal rivet; a connection hole extending in a vertical direction through the plate body with the terminal rivet accommodated therein; a first guide part defining a groove part outside the connection hole at where the welding fixing part is formed; and a second guide part defining a groove part connecting the groove of the first guide part to the outside of the plate body.

Gas generated when the welding fixing part is formed moves along the first guide part and is discharged to the outside of the terminal plate along the second guide part.

The groove of the first guide part may extend in a ring shape along an outer circumference of the connection hole.

The welding fixing part may be a welding seam formed by welding for fixing the busbar to the terminal plate, and the welding fixing part may have a protrusion extending from the busbar and fixed to the first guide part.

The terminal plate may have a terminal top surface protruding from the plate body toward the busbar to be in surface contact with and electrically connected to the busbar.

The first guide part and the busbar may be spaced apart from each other. A distance between the first guide part and the busbar may be in a range of 0.1 mm to 0.4 mm.

### BRIEF DESCRIPTION OF THE DRAWINGS

The following drawings attached in this specification illustrate embodiments of the present disclosure and are included to provide a further understanding the aspects and features of the present description along with the detailed description. Thus, the present disclosure should not be construed as being limited to the embodiments illustrated in the drawings;

FIG. 1 is a perspective view of a battery module according to an embodiment;

FIG. 2 is a front view of the battery module shown in FIG. 1;

FIG. 3 is a perspective view of a battery cell according to an embodiment;

FIG. 4 is a cross-sectional view of the battery cell shown in FIG. 3;

FIG. 5 is a perspective view of a busbar according to an embodiment;

FIG. 6 is a cross-sectional view of a state in which the busbar is fixed to a terminal part according to an embodiment;

FIG. 7 is a perspective view of terminal parts of two adjacent battery cells according to an embodiment;

FIG. 8 is a perspective view of the terminal part shown in FIG. 7;

FIG. 9 is a perspective view of a position at a welding fixing part is which installed on the terminal part shown in FIG. 8;

FIG. 10 is a plan view of the terminal part shown in FIG. 8; and

FIG. 11 is a plan view of a terminal part according to another embodiment.

### DETAILED DESCRIPTION

Hereinafter, embodiments of the present disclosure will be described below, in detail, with reference to the accompanying drawings. Accordingly, it should be apparent to those skilled in the art that the following description of embodiments of the present disclosure is provided for illustration purposes and not for the purposes of limiting the present disclosure, which is defined by the appended claims and their equivalents. Thus, because the embodiments described in this specification and the configurations shown in the drawings are some embodiments of the present disclosure and do not represent all of the aspects, features, and embodiments of the present disclosure, it should be understood that there may be various equivalents and modifications that can be substituted for them at the time of this application.

Also, the expressions “comprise” and “include” and/or “comprising” and “including” as used in this specification neither define the mentioned shapes, numbers, steps, operations, members, elements, and/or groups of these nor exclude the presence or addition of one or more other different shapes, numbers, steps, operations, members, elements, and/or groups of these, or addition of these.

In addition, the shapes and the sizes of elements in accompanying drawings may be exaggerated for more apparent description. In addition, the same reference numbers may be assigned to the same components in different embodiments.

The reference to two objects of comparison being “the same” means “substantially the same.” Substantially identical may include a deviation that is considered to a low level in the art, for example, a deviation of less than 5%. In addition, uniformity of a parameter at a certain area may mean uniformity from an average perspective.

It will be understood that although the terms of first and second are used herein to describe various elements, these elements should not be limited by these terms. These terms are only used to distinguish one component from another component, and unless specifically stated to the contrary, the first component may also be a second component.

Throughout this specification, unless specifically referred to the contrary, each component may be singular or plural.

An arrangement of any component on an upper portion (or lower portion) of a component or on a top (or bottom) of a component means that any component is placed in contact with a top surface (or bottom surface of the component, as well as other elements are interposed between the element and any element disposed above (or below) the element.

In addition, if a component is described as being “coupled,” “connected,” or “on” another component, it should be understood that the above components may be directly coupled, connected, or on each other, but other components may be “interposed” between each component, or each component may be “coupled,” or “connected” through another component.

As used in this specification, the term “and/or” includes any and all combinations of one or more of the associated listed items. Additionally, the use of “may” when describing embodiments of the present disclosure relates to “one or more embodiments of the present disclosure.” “One or more” preceding a list of elements and an expression such as “one or more” modify the entire list of elements and do not modify individual elements in the list.

Throughout the specification, if referring to A and/or B, this means A, B or A and B, unless there is a special statement to the contrary, and if referring to C to D, this means C or higher and D or lower, unless specifically stated to the contrary.

Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof.

The term “use” may be considered synonymous with the term “utilize.” As used in this specification, the terms “substantially,” “about,” and similar terms are used as terms of approximation rather than terms of degree and are taken into account the inherent variation in measured or calculated values that a general engineer of a person of ordinary skill in the art would recognize.

Although the terms first, second, third, etc. are used herein to describe various elements, components, regions, layers and/or sections, these elements, components, regions, layers and/or sections should not be limited by these terms. This term is used to distinguish one element, component, area, layer, or cross-section from another element, component, area, layer, or cross-section. Accordingly, a first element, component, region, layer, or section discussed below may be named a second element, component, region, layer, or section without departing from the teachings of the exemplary embodiments.

For ease of explanation, spatial relative terms such as “beneath”, “below”, “lower”, “above”, “upper”, etc. may be used herein to describe the relationship of one element or feature to another element(s) or feature(s) as shown in the drawings. The spatial relative position will be understood to encompass different directions of the device in use or operation in addition to the direction depicted in the figures. For example, if the device in the drawing is turned over, elements described as “below” or “bottom” other elements are understood to be “above” or “above” other elements. Accordingly, the term “below” can encompass both upward and downward directions.

The terms used in this specification are for describing embodiments of the present disclosure and are not intended to limit the disclosure. Further, the terms used in the following description and claims are not limited to their dictionary meanings but are used to enable a clear and consistent understanding of the present disclosure.

A battery cell 100 and a battery module 1 including the battery cell 100 according to some embodiments of the present disclosure will be described with reference to the drawings.

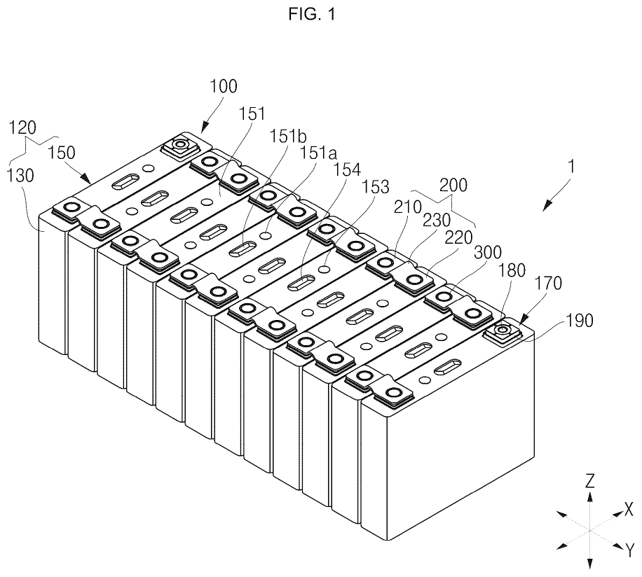

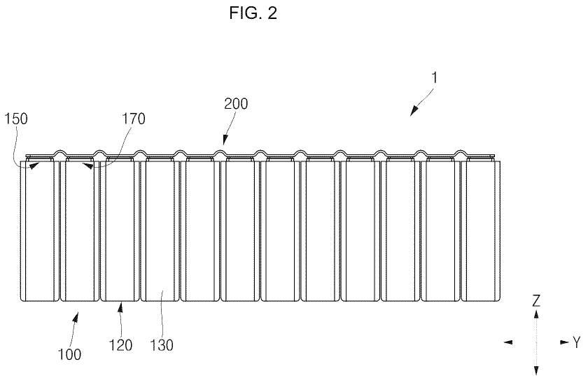

FIG. 1 is a perspective view of the battery module 1 according to an embodiment, and FIG. 2 is a front view of the battery module 1 shown in FIG. 1. As illustrated in FIGS. 1 and 2, the battery module 1, according to some embodiments, may include a terminal part 170, a plurality of battery cells 100 arranged in (e.g., adjacent to each other in) one direction, and a busbar 200 connecting adjacent ones of the battery cells 100 to each other.

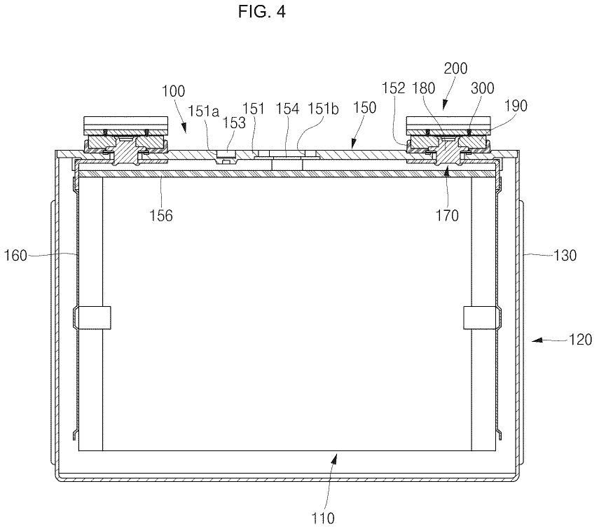

The battery cell 100 may include a housing 120, an electrode assembly 110 accommodated in the housing 120, and an electrolyte (see, e.g., FIG. 4). The electrode assembly 110 and the electrolyte may react electrochemically to generate energy. The terminal part 170 is electrically connected to the busbar 200, and a vent hole (e.g., a vent opening) 151b, which is an exhaust passage for a gas generated in the housing 120, may be provided at one side of the battery cell 100. A terminal provided in the terminal part 170 of the battery cell 100 may include a terminal rivet 180 and a terminal plate 190 and may be a positive electrode terminal or a negative electrode terminal, which have different polarities from each other, and terminal parts 170 of the adjacent battery cells 100 may be electrically connected to each other in series or in parallel by the busbar 200, which will be described later. Although an embodiment having a serial connection is described as an example, the present disclosure is not limited thereof, and thus, various connection structures or configurations can be implemented. Additionally, the number and arrangement of battery cells 100 are not limited to the configuration illustrated in FIG. 1 and may be changed as needed.

The plurality of battery cells 100 may be arranged in one direction so that wide surfaces of the battery cells 100 face each other, and the plurality of arranged battery cells 100 may be fixed by the housing 120.

The terminal part 170 and the busbar 200 may be connected to each other by any one of soldering, resistance welding, laser welding, or projection welding.

In the state in which the busbar 200 is installed to face the terminal part 170 of the battery cell 100, the busbar 200 may be fixed to the terminal part 170 by welding. A welding fixing part (e.g., a weld) 300 may be provided by a welding seam generated during welding, and this welding fixing part 300 may be a conductor connected to each of the busbar 200 and the terminal part 170. A space is provided between the busbar 200 and the terminal part 170 so that gas generated if the welding fixing part 300 is formed by the welding may be discharged to the outside of the terminal part 170 through the space defined between the terminal part 170 and the busbar 200.

The battery module 1, according to some embodiments, may include the battery cell 100, the busbar 200, and the welding fixing part 300. If laser welding is utilized to fix the busbar 200 to the terminal part 170, a resulting melting pool may be cooled to provide the welding fixing part 300. If there are many pores inside the welding fixing part 300, a welding area (or a welded area) may be reduced, and strength of the welding fixing part 300 may be reduced. In some embodiments, a passage for discharging a gas between the busbar 200 and the terminal part 170 is provided at where the welding fixing part 300 is formed to reduce or prevent the formation of pores in the welding fixing part 300. In some embodiments, a cross-sectional area of the welding fixing part 300 may be increased to improve the strength of the welding fixing part 300.

Directions used in the present disclosure will be defined for ease of understanding, but the present disclosure is not limited thereto. A first direction may be defined as a width direction and as an x-axis direction in the drawings, a second direction may be defined as a longitudinal direction and a y-axis direction in the drawings, and a third direction may be defined as a vertical direction and a z-axis direction in the drawings.

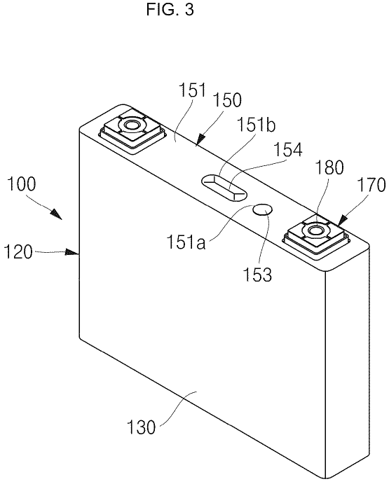

FIG. 3 is a perspective view of the battery cell 100 according to an embodiment, and FIG. 4 is a cross-sectional view of the battery cell 100 shown in FIG. 3. As illustrated in FIGS. 3 and 4, the battery cell 100 may include the electrode assembly 110, the housing 120, a current collector 160, and the terminal part 170.

The electrode assembly 110 may be provided by stacking or stacking and winding a first electrode plate, a separator, and a second electrode plate, each of which is provided as a thin plate or film. When the electrode assembly 110 is a stacked electrode assembly, a winding axis may be parallel to the width direction (e.g., the x-axis direction) of the housing 120. In some embodiments, the electrode assembly 110 may be a stacked electrode assembly rather than a winding (or wound) electrode assembly, but the shape of the electrode assembly 110 is not limited in the present disclosure. In some embodiments, the electrode assembly 110 may include a Z-stack electrode assembly 110 in which a positive electrode plate and a negative electrode plate are inserted into both sides of the separator, which is then bent in the form of a Z-stack. In some embodiments, the electrode assembly 110 may be stacked so that one or more electrode assemblies 110 are adjacent to each other and accommodated in the housing 120. The number of electrode assemblies 110 in the housing 120 is not limited in the present disclosure. In some embodiments, the first electrode plate of the electrode assembly 110 may act as a negative electrode, and the second electrode plate may act as a positive electrode. In other embodiments, the first electrode plate may act as a negative electrode, and the second electrode plate may act as a positive electrode.

A first electrode tab of the first electrode plate and a second electrode tab of the second electrode plate may be disposed on both ends of the electrode assembly 110 as described above, respectively. In some embodiments, the electrode assembly 110 may be accommodated in the housing 120 together with an electrolyte. In some embodiments, the electrode assembly 110 may be electrically connected to the respective terminal parts 170 by welding the current collector 160 to the first electrode tab of the first electrode plate and the second electrode tab of the second electrode plate, which are exposed at both sides of the electrode assembly 110.

The housing 120 may be modified in various ways as long as it accommodates the electrode assembly 110. The housing 120, according to some embodiments, may include a case 130 and a cap assembly 150.

The case 130 may have a hollow rectangular parallelepiped shape having an opening at an upper portion thereof. The electrode assembly 110 may be inserted into the case 130 through the opening. In some embodiments, the current collector 160 that electrically connects the electrode assembly 110 to the terminal part 170 may also be disposed inside the case 130. The case 130 may have a rectangular bottom surface and four side surfaces extending in an approximately vertical direction from the four sides (or four edges) of the bottom surface.

The cap assembly 150 may be coupled to the case 130. In some embodiments, the cap assembly 150 may include a cap plate 151, seal gasket 152, a stopper 153, a safety vent 154, and an insulating member 156.

The cap plate 151 may seal the opening in the case 130 and may be made of the same material as that of the case 130. In some embodiments, although not limited thereof, the cap plate 151 may be coupled to the case 130 by laser welding. When the cap plate 151 has the same polarity as that of one side of the terminal part 170 (e.g., as one of the terminal parts 170), as described above, the cap plate 151 and the case 130 may have the same polarity. An electrolyte injection hole (or opening) 151a and a vent hole (or opening) 151b that pass (or extend) between a top surface and a bottom surface of the cap plate 151 may be provided in the cap plate 151.

The seal gasket 152 may be made of an insulating material and may be installed between the cap plate 151 and a terminal plate 190 provided in the terminal part 170. The seal gasket 152 may be installed in a space defined by a terminal rivet 180, the terminal plate 190, and the cap plate 151. In some embodiments, the seal gasket 152 may seal a gap between the terminal plate 190 and the cap plate 151 and may also seal a circumference of the terminal rivet 180. The seal gasket 152 may prevent external moisture from permeating into the inside of the battery cell 100 and/or may prevent the electrolyte contained in the battery cell 100 from leaking to the outside. In some embodiments, the seal gasket 152 may be made of an elastic insulating material and may block electrical connection between the terminal part 170 and the cap plate 151.

The stopper 153 may seal the electrolyte injection hole 151a after the electrolyte is injected into the housing 120 through the electrolyte injection hole 151a in the cap plate 151.

The safety vent 154 may be installed at a position facing the vent hole 151b in the cap plate 151 and may be opened at (e.g., may burst at) a reference (or set) pressure. The safety vent 154 may be installed in the cap plate 151 to close or open the vent hole 151b.

The insulating member 156 may have a shape corresponding to that of the cap plate 151 and may be modified into various shapes as long as it can be installed between the cap plate 151 and the electrode assembly 110. The insulating member 156 may have a size that roughly corresponds to the bottom surface of the cap plate 151 and may be installed to be in close contact with or spaced apart from the bottom surface of the cap plate 151. In some embodiment, holes (or openings) may be defined in the insulating member 156 at positions corresponding to the electrolyte injection hole 151a and the vent hole 151b, which are defined in the cap plate 151. The insulating member 156 may prevent a short circuit from occurring between the current collector 160 and the cap plate 151.

In addition, the insulating member 156 may have a size corresponding to that of the cap plate 151 to prevent a short circuit between the electrode assembly 110 and the cap plate 151. The insulating member 156 may be made of polyphenylene sulfide (PPS), which has a relatively high melting point (e.g., about 285° C.) and a relatively high tensile strength, to prevent heat from being transferred to the adjacent cell when heat due to an internal short circuit caused by, for example, penetration of the secondary battery and to prevent material from being discharged through the safety vent 154, thereby improving safety. The insulating member 156 may prevent heat caused by an internal short circuit in the battery cell 100 from being transferred to the adjacent battery cell 100 through the cap assembly 150. In some embodiments, if the battery cell 100 is provided as one unit cell, because blocking or reducing heat transfer to an adjacent secondary battery is not required, the insulating member 156 may be made of polypropylene (PP).

The current collector 160 may include a first current collector that is in contact with the first electrode tab protruding at (or from) one end of the electrode assembly 110 and a second electrode tab that is in contact with the second electrode tab protruding at (or from) the other end of the electrode assembly 110. The current collector 160 may have a bent shape and may be installed inside the housing 120 and may electrically connect the electrode assembly 110 to the terminal rivet 180 of the terminal part 170. The current collector 160 may have a terminal hole (or opening), and the terminal rivet 180 may be inserted into the terminal hole and may then be riveted and/or welded. In some embodiments, the first current collector may be made of copper or a copper alloy, and the second current collector may be made of aluminum or an aluminum alloy, for example, but they are not limited thereto.

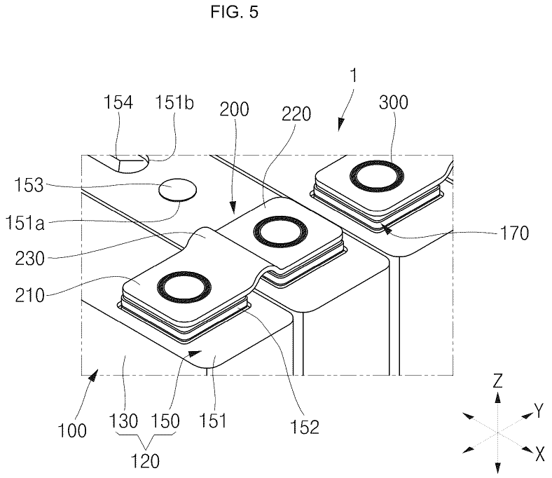

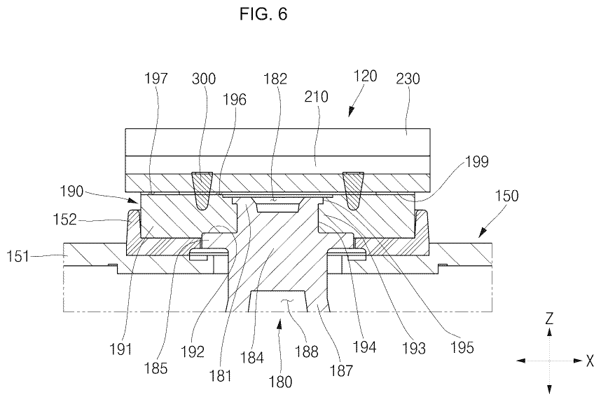

FIG. 5 is a perspective view of the busbar 200 according to an embodiment, and FIG. 6 is a cross-sectional view of a state in which the busbar 200 is fixed to the terminal part 170, according to an embodiment. As illustrated in FIGS. 5 and 6, the terminal part 170 may be modified in various manners as long as it is electrically connected to the electrode assembly 110. The terminal part 170 may be electrically connected to the electrode assembly 110 and may protrude to the outside of the housing 120 to face the busbar 200. The terminal part 170 may be electrically connected to the busbar 200 through the welding fixing part 300. In some embodiments, because the terminal part 170 and the busbar 200 are installed to be in contact with each other, the terminal part 170 and the busbar 200 may be electrically connected to each other. The terminal part 170, according to some embodiments, may include the terminal rivet 180 and the terminal plate 190. The terminal rivet 180 and the terminal plate 190 may be electrically connected to each other. The terminal part 170 may be divided into a positive electrode and a negative electrode depending on the polarity connected to the electrode assembly 110 (e.g., depending on how it is connected to the electrode assembly 110).

The terminal part 170 may be variously modified as long as it is connected to the housing 120 and is provided with a guide part that guides the discharge of a gas, which is generated when the terminal part 170 and the busbar 200 are welded to each other, to the outside of the terminal part 170.

The terminal rivet 180 may be electrically connected to the electrode assembly 110 and may have one side disposed inside the housing 120 of the battery cell 100 and the other side disposed outside the housing 120. The terminal rivet 180 may be variously modified as long as it is installed on the cap plate 151 and connected to the terminal part 170. The terminal rivet 180 may extend in the vertical direction z, and a lower side (e.g., a lower end) of the terminal rivet 180 may be in contact with the current collector 160 to receive current through the current collector 160. The terminal rivet 180 may be fixed in a state of being inserted into a connection hole (e.g., a connection opening) 193 provided in the terminal plate 190 and, thus, may be electrically connected to the terminal plate 190.

The terminal rivet 180, according to some embodiments, may include a rivet head 181, a rivet body 184, and a rivet tail 187. A concave first rivet groove 182 may be defined in an upper end of the rivet head 181. A protrusion may be provided on an edge of the rivet head 181 protruding outwardly therefrom, and a stepped portion provided on the connection hole of the terminal plate 190 to prevent the terminal rivet 180 from being separated to a lower side of the terminal plate 190 (e.g., to prevent the terminal rivet 180 from falling into the housing 120).

The rivet body 184 may extend below (e.g., from a bottom of) the rivet head 181 and may be disposed inside the connection hole 193 in the terminal plate 190 together with the rivet head 181. A hook protrusion 185 that protrudes in a horizontal direction from the rivet body 184 may be hooked with (e.g., may be inserted into) a lower groove 192 provided in the terminal plate 190 to restrict movement of the terminal rivet 180 in the vertical direction (e.g., the Z-axis direction) and the horizontal direction (e.g., the X-axis direction).

The rivet tail 187 may extend to the lower side of (e.g., may extend from the lower side of) the rivet body 184 and may be fixed to be in contact with the current collector 160. A second rivet groove 188 having a concave groove shape may be defined in a lower end of the rivet tail 187. Because the rivet tail 187 is fixed to be in contact with the current collector 160, which is electrically connected to the electrode assembly 110, the rivet tail 187 may have the same polarity as the current collector 160.

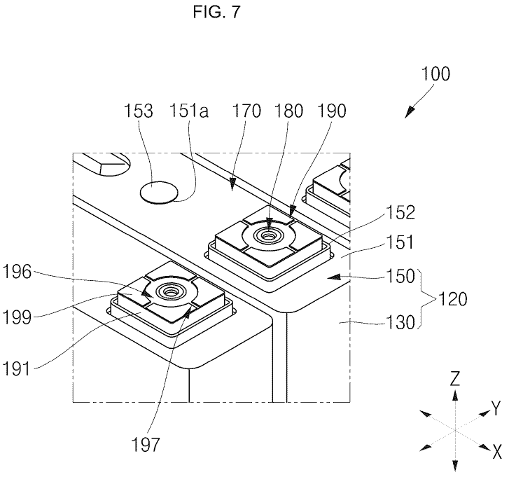

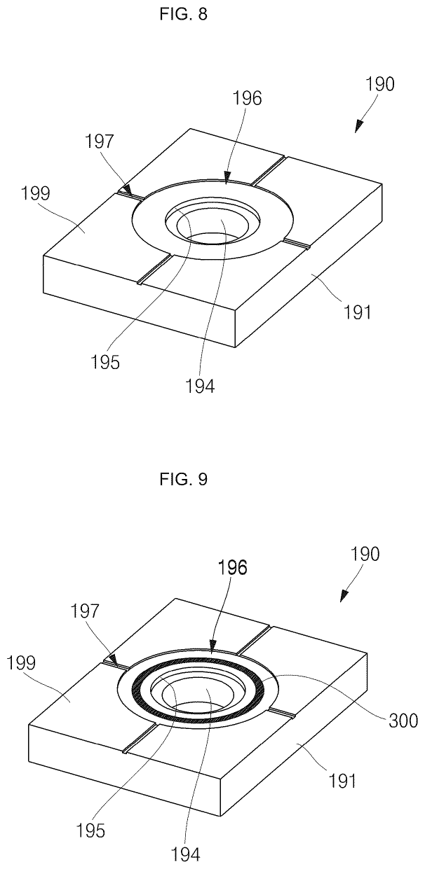

FIG. 7 is a perspective view of the battery cell 100 provided with the terminal part 170 according to an embodiment, and FIG. 8 is a perspective view of the terminal part 170 according to an embodiment. As illustrated in FIGS. 7 and 8, the terminal plate 190 may be disposed outside the cap plate 151 provided in (or on) the housing 120. The terminal plate 190 may be electrically connected to the terminal rivet 180. Because the terminal plate 190 has an area that is in contact with the busbar 200 and an area that is spaced apart from the busbar 200, when the welding fixing part 300 is provided (or formed) by welding, a gas inside the welding fixing part 300 may be discharged to the outside of the terminal plate 190 through the space at where the terminal plate 190 and the busbar 200 are spaced apart from each other. The terminal plate 190, according to some embodiments, may include a plate body 191, the connection hole 193, a first guide part 196, a second guide part 197, and a terminal top surface 199.

The plate body 191 may be variously modified as long as it is disposed outside the cap plate 151 provided in the housing 120 and electrically connected to the terminal rivet 180. The plate body 191 may be disposed above the cap plate 151, and the seal gasket 152 may be installed between the plate body 191 and the cap plate 151 to provide insulation. The plate body 191 may have a square plate shape, and a lower groove 192 into which the hook protrusion 185 of the terminal rivet 180 is inserted may be defined in a bottom of the plate body 191 (see, e.g., FIG. 6).

The connection hole 193 may be variously modified as long as it defines a hole (e.g., an opening) in the plate body 191 in the vertical direction so that the terminal rivet 180 is disposed therein. The connection hole 193, according to some embodiments, may include a first connection hole 194 in which the rivet body 184 is disposed and a second connection hole 195 disposed above the first connection hole 194 and in which a protrusion provided outside the rivet head 181 is disposed. The first connection hole 194 may communicate with (e.g., may be open to) the lower groove 192. A diameter of the first connection hole 194 may be less than that of the second connection hole 195.

The guide part provided on the terminal part 170 of the battery cell 100 to guide the gas discharge may include a first guide part 196 and a second guide part 197.

The first guide part 196 may be variously modified as long as it defines a groove part outside the connection hole 193 depending on the position at where the welding fixing part 300 is provided. The first guide part 196, according to some embodiments, may define a groove part extending in a ring shape along an outer circumference of the connection hole 193. The first guide part 196 and the busbar 200 may be spaced apart from each other at an interval from. A gap between the first guide part 196 and the busbar 200, according to some embodiments, may be in a range of about 0.1 mm to about 0.4 mm. If the gap between the first guide part 196 and the busbar 200 is less than about 0.1 mm, a gas discharged to the outside of the welding fixing part 300 may not smoothly move between the first guide part 196 and the busbar 200. If the gap between the first guide part 196 and the busbar 200 exceeds about 0.4 mm, an external shape of the terminal part 170 may increase to cause interfere with other components.

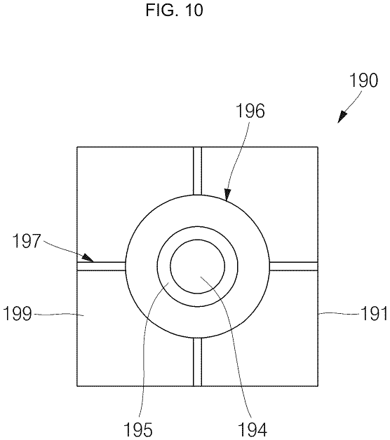

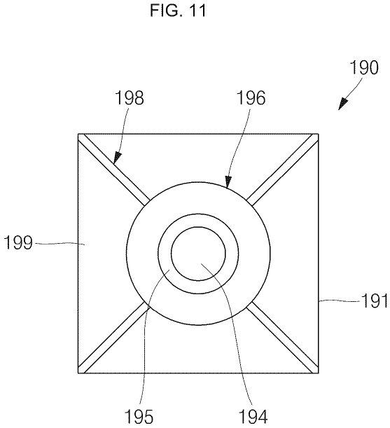

FIG. 9 is a perspective view of a position at where the welding fixing part 300 is formed on the terminal part 170 according to an embodiment, and FIG. 10 is a plan view of the terminal part 170 according to an embodiment. As illustrated in FIGS. 9 and 10, the second guide part 197 may be variously modified as long as it defines the groove part connecting the first guide part 196 to the outside of the plate body 191. The second guide part 197 may define a groove part in the terminal top surface 199, which will be described later, to communicate with the second guide part 197. The second guide part 197 may be provided in plurality.

The gas generated when the welding fixing part 300 is provided may move along the first guide part 196 to be easily and quickly discharged to the outside of the terminal plate 190 along the second guide part 197. For example, the second guide part 197 may have a cross shape with the connection hole 193 as its center.

The terminal rivet 180 may be installed at the center of the terminal plate 190, the first guide part 196 may be disposed in an outer circumference of the terminal rivet 180, and the welding fixing part 300 may be disposed in a circumferential direction inside the first guide part 196. The second guide part 197, which defines a groove part connected to the first guide part 196, may define a cross-shaped groove centered about the terminal rivet 180.

The terminal top surface 199 may be variously modified as long as it protrudes from the plate body 191 toward the busbar 200 to be in surface contact with the busbar 200 and to be electrically connected thereto. The terminal top surface 199, according to some embodiments, may be disposed outside the first guide part 196 and may be disposed above the first guide part 196 in a planar shape that protrudes upwardly. In some embodiments, when a thickness between the terminal top surface 199 and the bottom surface of the plate body 191 is T1, and a thickness between the first guide part 196 and the bottom surface of the plate body 191 is T2, T1 may be greater than T2.

As illustrated in FIGS. 5 and 6, the busbar 200 may be variously modified as long as it can be electrically connected to the battery cell 100. The busbar 200, according to some embodiments, may include a first connection plate 210, a second connection plate 220, and a curved connection part 230.

The first connection plate 210 may be variously modified as long as it can contact the terminal part 170 and be electrically connected. thereto The second connection plate 220 may be variously modified as long as it can be installed to be spaced apart from the first connection plate 210, be in contact with the adjacent terminal part 170, and be electrically connected thereto.

The first connection plate 210 and the second connection plate 220, according to some embodiments, may be disposed above the terminal plate 190 and may be fixed in a state of being in contact with the terminal plate 190 through the welding fixing part 300. In some embodiments, each of the first connection plate 210 and the second connection plate 220 may have a square plate shape.

The curved connection part 230 may be variously modified as long as it connects the first connection plate 210 to the second connection plate 220 and has a curved surface. Because the curved connection part 230, according to some embodiments, is a plate bent into a curved shape, even if a distance of the terminal part 170 connected by the busbar 200 (e.g., a distance between to adjacent terminal parts connected by the busbar 200) changes, the curved connection part 230 may be bent or unbent (e.g., straightened), and thus, the connection between the busbar 200 and the terminal part 170 may be stably provided.

The welding fixing part 300 may be variously modified as long as it fixes the busbar 200 to the terminal part 170 of the battery cell 100 by welding. The welding fixing part 300 may be a welding seam provided by (or formed by) welding to fix the busbar 200 to the terminal plate 190 and may extend from the busbar 200 to provide a protrusion fixed to the first guide part 196.

When the busbar 200 is disposed on the upper portion the terminal plate 190, the busbar 200 may be in contact with a top surface of the terminal plate 190. When the laser welding is performed from the upper side of the busbar 200 toward the first guide part 196 of the terminal plate 190, the weld seam may extend to the lower side of the busbar 200, and thus, the terminal plate 190 disposed on the first guide part 196 may be partially melted and then solidified. During the welding, the gas inside the welding fixing part 300 may be discharged into the space defined by the first guide part 196 to prevent pores from being defined inside the welding fixing part 300.

The welding fixing part 300 may provide a ring-shaped protrusion extending in the circumferential direction on the outside of the terminal rivet 180, and also, the upper side of the welding fixing part 300 may be fixed to the busbar 200 and the lower side of the welding fixing part 300 may be fixed to the terminal plate 190.

FIG. 11 is a plan view of a terminal part 170 according to another embodiment. As illustrated in FIG. 11, a second guide part 198 may be formed radially around a connection hole 193. The second guide part 198, which communicates with a first guide part 196, may be formed radially around a terminal rivet 180 or the connection hole 193 to guide a gas discharged to the first guide part 196 to the outside of a terminal plate 190.

As described above, a space (or channel) for gas discharge may be formed between the terminal part 170 and a busbar 200 to guide discharge of gas generated during welding, and thus, a welding area welded by the welding fixing part 300 may increase to provide improved welding strength.

In some embodiments, when a gap (e.g., in a range of about 0.1 mm to about 0.4 mm) is maintained between the busbar 200 and the terminal part 170, a size of the welding fixing part 300 may increase by inducing spreading of a melting pool to increase the size of the welding fixing part 300, and thus, the discharge of gas trapped inside the welding fixing part 300 may be induced to remove or prevent the pores. In some embodiments, when a gap is maintained between the busbar 200 and the terminal part 170, higher strength may be maintained than if welding without the gap between the busbar 200 and the terminal part 170.

According to embodiments of the present disclosure, the discharge of gas generated when the busbar is welded may be induced to secure a wide welding bonding area, thereby providing a higher strength weld.

However, aspects and features of the present disclosure are not limited to the above-described aspects and features, and other aspects and features not mentioned herein can be clearly understood by those skilled in the art from the description of the present disclosure and the claims, provided below.

While embodiments of the present disclosure have been described with reference to drawings, it will be apparent to those skilled in the art that various changes and modifications may be made without departing from the spirit and scope of the present disclosure as defined in the following claims and their equivalents.

What is claimed is:

1. A battery cell comprising:
an electrode assembly;
a case accommodating the electrode assembly;
a cap plate sealing an opening in the case; and
a terminal part connected to the cap plate and having a guide part along which a gas generated when a busbar is welded to the terminal part is discharged to the outside.

2. The battery cell of claim 1, wherein the terminal part comprises:
a terminal rivet in the cap plate and connected to the terminal part; and
a terminal plate electrically connected to the terminal rivet and having with an area that is in contact with the busbar and an area that is spaced apart from the busbar.

3. The battery cell of claim 2, wherein the terminal plate comprises:
a plate body outside the cap plate and electrically connected to the terminal rivet;
a connection hole extending in a vertical direction through the plate body to accommodate the terminal rivet therein;
a first guide part defining a groove outside the connection hole; and
a second guide part defining a groove that connects the first guide part to the outside of the plate body.

4. The battery cell of claim 3, wherein the groove of the first guide part extends in a ring shape along an outer circumference of the connection hole.

5. The battery cell of claim 3, wherein a distance between the first guide part and the busbar is in a range of 0.1 mm to 0.4 mm.

6. The battery cell of claim 3, wherein the second guide part defines a plurality of grooves.

7. The battery cell of claim 3, wherein the second guide part extends radially from the connection hole.

8. The battery cell of claim 3, wherein the second guide part has a cross shape with the connection hole as its center.

9. The battery cell of claim 3, wherein the terminal plate has a terminal top surface protruding from the plate body toward the busbar to be in surface contact with and electrically connected to the busbar.

10. The battery cell of claim 9, wherein the terminal top surface is above the first guide part.

11. A battery module comprising:
a battery cell comprising a terminal part electrically connected to an electrode assembly;
a busbar electrically connected to the terminal part; and
a welding fixing part fixing the busbar to the terminal part,
wherein a gas generated when the welding fixing part is formed is discharged to the outside of the terminal part through a space defined between the terminal part and the busbar.

12. The battery module of claim 11, wherein the busbar comprises:
a first connection plate that is in contact with and electrically connected to the terminal part;
a second connection plate spaced apart from the first connection plate and in contact with and electrically connected to a terminal part of an adjacent battery cell; and
a curved connection part connecting the first connection plate to the second connection plate and having a curved surface.

13. The battery module of claim 11, wherein the terminal part comprises:
a terminal rivet in a cap plate of the battery cell and connected to the terminal part; and
a terminal plate electrically connected to the terminal rivet and having an area in contact with the busbar and an area spaced apart from the busbar.

14. The battery module of claim 13, wherein the terminal plate comprises:
a plate body outside the cap plate and electrically connected to the terminal rivet;
a connection hole extending in a vertical direction through the plate body with the terminal rivet accommodated therein;
a first guide part defining a groove part outside the connection hole at where the welding fixing part is formed; and
a second guide part defining a groove part connecting the groove of the first guide part to the outside of the plate body.

15. The battery module of claim 14, wherein a gas generated when the welding fixing part is formed moves along the first guide part and is discharged to the outside of the terminal plate along the second guide part.

16. The battery module of claim 1, wherein the groove of the first guide part extends in a ring shape along an outer circumference of the connection hole.

17. The battery module of claim 14, wherein the welding fixing part is a welding seam formed by welding for fixing the busbar to the terminal plate, and wherein the welding fixing part has a protrusion extending from the busbar and fixed to the first guide part.

18. The battery module of claim 14, wherein the terminal plate has a terminal top surface protruding from the plate body toward the busbar to be in surface contact with and electrically connected to the busbar.

19. The battery module of claim 14, wherein the first guide part and the busbar are spaced apart from each other.

20. The battery module of claim 14, wherein a distance between the first guide part and the busbar is in a range of 0.1 mm to 0.4 mm.
